(19) United States
(12) Patent Application Publication
(10) Pub. No.: US 2022/0261490 A1
(43) Pub. Date: Aug. 18, 2022

(54) METHOD FOR PROVIDING A DIGITAL TWIN FOR A NONDIGITAL AUTOMATION ENGINEERING FIELD DEVICE

(71) Applicant: Endress+Hauser Process Solutions AG, Reinach (CH)

(72) Inventors: Daniel Ens, Lörrach (DE); Andreas Buchdunger, Neuenburg (DE); Enrico Mario De Stasio, Fey (CH)

(21) Appl. No.: 17/618,601

(22) PCT Filed: Jun. 9, 2020
(86) PCT No.: PCT/EP2020/065988

§ 371 Date: Dec. 13, 2021

(30) Foreign Application Priority Data
Jun. 13, 2019 (DE) 10 2019 116 120.7

(51) Int. Cl. G06F 21/62; G06F 21/73; H04L 67/1097

(52) U.S. Cl. CPC G06F 21/6218; H04L 67/1097; G06F 21/73

(57) ABSTRACT

A method for providing a digital twin for a nondigital automation engineering field device, comprising the following method steps: connecting a connecting unit to the nondigital field device; downloading data concerning the connecting unit that are held in the nondigital field device; producing a timestamp for the downloaded data; transmitting the downloaded data together with the timestamp to a cloud; instantiating a digital image of the nondigital field device in the cloud; producing and providing an authenticated link for downloading the digital twin; downloading the digital twin; linking the digital twin executed on the computer unit to a product database located in the cloud; checking whether the product data held in the product database have undergone a change in comparison with the data that were supplied to the digital image at the time of the timestamp.

The invention relates to a method for providing a digital twin for a nondigital automation engineering field device.

In automation engineering, especially in process automation engineering, field devices are frequently used to determine, optimize and/or influence process variables. Sensors are used to sense process variables; for example, fill level measuring devices, flow meters, pressure and temperature measuring devices, conductivity meters, etc. are used for sensing the respective process variables of fill level, flow, pressure, temperature, and conductivity. Actuators, such as, for example, valves or pumps, are used to influence process variables. The flow rate of a fluid in a pipeline section or a filling level in a container can thus be altered by means of actuators. In principle, all devices which are process-oriented and which supply or process process-relevant information are referred to as field devices.

A variety of such field devices are manufactured and marketed by the Endress+Hauser company.

At present, field devices that are connected via a two-wire line to a higher-level unit, for example a control unit PLC, are also common in a large number of existing automation systems. The field devices already in the automation system are also commonly referred to as an installed base. The field devices are designed in such a way that the measured values or control values are communicated, i.e. transmitted, as a main process variable via the two-wire line or two-wire cable in analog form in the form of a 4-20 mA signal, which is why they are also referred to as two-wire field devices. The HART protocol, in which a frequency signal is superimposed as a digital two-wire signal on the analog current signal of 4-20 mA for data transmission, has proven especially effective for transmitting all other data. According to the HART protocol, a switch is made between 1200 Hz and 2400 Hz for data transmission, wherein the lower frequency stands for a logical “0” and the higher frequency standing for a logical “1.” In this way, the analog current signal, which can be varied only slowly, remains unaffected by the frequency superposition, and therefore analog and digital communication is combined by means of HART.

Due to the limitation of the communication of such two-wire field devices via the two-wire line, the connection of the field devices to a digital platform, for example a Manufacturing Execution System (MES), an enterprise resource planning (ERP) system or a cloud platform, is not readily possible. The two-wire field devices function virtually autonomously in the automation system, i.e., they do not have any contact with the IT world outside of the automation system, i.e., they are not digitally capable.

The invention is thus based on the object of finding a way of enabling two-wire field devices that still communicate data via the conventional two-wire line and do not have a connection to the IT world outside the automation system to become digitally capable.

The object is achieved according to the invention by the method according to patent claim 1.

The method according to the invention for providing a digital twin for a nondigital automation engineering field device comprises the following method steps:
a) connecting a connecting unit to the nondigital field device;
b) downloading data that are held in the nondigital field device to the connecting unit;
c) producing a timestamp for the downloaded data;
d) transmitting the downloaded data together with the timestamp to a cloud;
e) instantiating a digital image of the nondigital field device in the cloud, wherein the transmitted data and further data specific to the nondigital field device that are stored in the cloud can be supplied to the digital image, so that the digital image comprises all the data available for the nondigital field device at a time of the timestamp, wherein the digital image is also provided with the timestamp;
f) producing and providing an authenticated link for downloading the digital twin for the nondigital field device from the cloud, wherein the digital twin comprises at least one asset administration shell and the digital image with the timestamp;
g) downloading the digital twin with the aid of the link and executing the digital twin on a computer unit, which is preferably operated by an operator of the nondigital field device;
h) linking the digital twin executed on the computer unit to a product database located in the cloud, which product database comprises product data that contain at least all the master data relevant to the nondigital field device, especially also a serial number, all the relevant data relating to a life cycle of the nondigital field device and/or the asset administration shell;
i) checking, preferably at regular intervals, whether the product data held in the product database have undergone a change in comparison with the data that were supplied to the digital image at the time of the timestamp.

According to the invention, it is proposed that each nondigital field device or a field device of the so-called installed base receive a digital twin. Or, in other words, the nondigital field device receives a digital representative to which an IP address is assigned, so that the digital twin can be used as a so-called Industry 4.0 component. For example, the digital twin is a component of a digital process system. At the time of creation, the digital twin receives all the data present in the nondigital field device and further data specific to the nondigital field device, which data are provided or held in the cloud, for example by the field device manufacturer. The data are encapsulated together with a timestamp that records the time of creation of the digital twin with an asset administration shell, wherein the asset administration shell reproduces all the properties and functionalities relevant to the nondigital field device. The digital twin also automatically receives an IP address by means of the asset administration shell, enabling simple, IP-based communication in the sense of Industry 4.0. Specifically, each connected digital twin can thus be uniquely identified and reached via a network, regardless of the age of the nondigital field device in the system. In this way, nondigital field devices can be connected quickly and easily to MES or ERP systems or a PLC.

An Exemplary Embodiment is Mentioned Below:
By combining the curve of error messages over time, trend information about the “state of health” of the field device can be identified in the digital twin.

An advantage of the method according to the invention is that, in addition to the data of its physical twin, the digital twin also contains, for example, all available configuration and service data produced over the course of its life cycle. This makes it possible to also provide digital twins for the large number of installed field devices that communicate only in analog form.

An advantageous embodiment of the method according to the invention further provides that a check is carried out as to whether there has been a change in the asset administration shell in comparison with the asset administration shell of the digital image.

An advantageous embodiment of the method according to the invention provides that, if there was a change in the data held in the product database in comparison with the data held in the digital image and/or a change in the asset administration shell, a trigger signal is output from the digital twin. Especially, the embodiment can provide that the trigger signal is output from the digital twin to a maintenance management system of the operator of the nondigital field device, so that the operator of the nondigital field device is informed of the change.

A further advantageous embodiment of the method according to the invention provides that a serial number, one or more parameters and/or one or more measured values are downloaded as data from the nondigital field device.

A further advantageous embodiment of the method according to the invention provides that the connecting unit is connected to the nondigital field device via a wireless connection.

An alternative embodiment of the method according to the invention provides that the connecting unit is connected to the nondigital field device by means of a connecting line.

A further advantageous embodiment of the method according to the invention provides that the connecting unit is designed as a stationary unit that is permanently connected to the nondigital field device, and wherein, if a change is detected, method steps c) to i) are carried out again.

A further advantageous embodiment of the method according to the invention provides that the connecting unit is designed as a mobile unit that, after the data is downloaded according to method step b), is disconnected from the nondigital field device, and wherein, if a change is detected, method steps a) to i) are carried out again.

The invention is explained in more detail based upon the following drawing. These show:

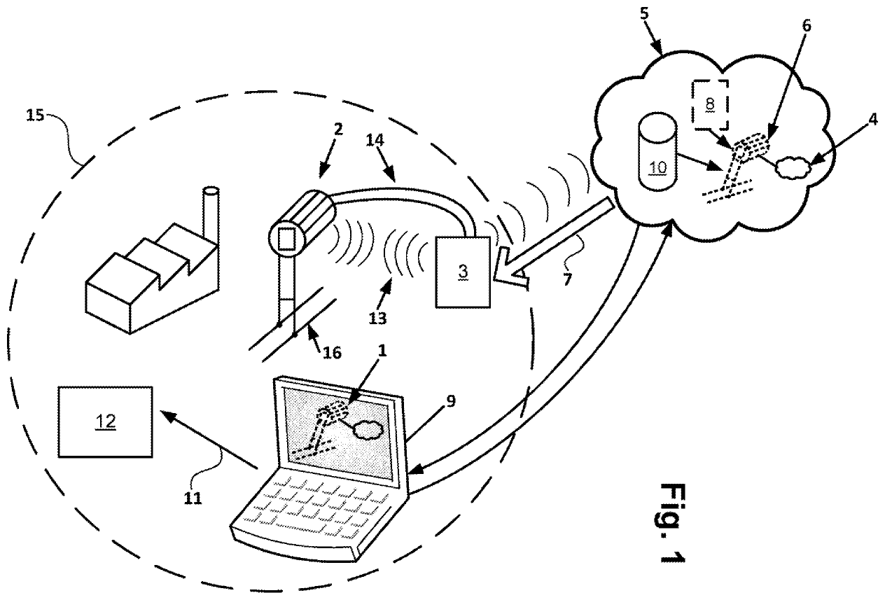

FIG. 1: a schematic representation of an automation system together with a cloud located outside the system in order to illustrate the method according to the invention.

FIG. 1 shows a schematic representation of an automation system 15 together with a cloud 5 located outside the system 15. The automation system 15 is operated by a system operator and comprises a plurality of two-wire field devices, which are connected to a higher-level unit via a two-wire line 16. The measured or control values for execution are transmitted via the two-wire line to a higher-level unit, not shown separately in FIG. 1, so that a process can be executed/controlled. A maintenance management system (CMMS) 12 can be operated by the plant operator to maintain and repair the automation system.

The method according to the invention for providing a digital twin 1 for a nondigital automation engineering field device or a two-wire field device 2 as is frequently used in the automation system 15 of the system operator, provides the following method steps: In a first method step a), a connecting unit 3 is connected to the nondigital field device 2 in the automation system 15. The connection can take place both via a line 14 and wirelessly if the two-wire field device already has a corresponding radio unit for wireless, especially wireless-near-field 13 data transmission. Both mobile units, such as smartphones or special portable connecting units customary in process automation, and stationary units, which are preferably permanently connected to the two-wire field device 2, can be used as the connecting unit.

In a next method step b), the data held in the nondigital field device 2 are downloaded by the connecting unit 3. Such data can comprise, for example, a serial number, one or more parameters, and/or one or more measured or control values.

A subsequent method step c) provides for the production of a timestamp 4 for the data downloaded from the two-wire field device 2. The timestamp is preferably produced in the connecting unit 3. The downloaded data are then transmitted together with the produced timestamp 4 to a cloud 5 in a method step d).

In a next method step e), a digital image 6 of the two-wire field device 2 is instantiated in the cloud 5. The digital image 6 comprises the transmitted data and further data specific to the two-wire field device 2, which data are held in the cloud 5 in a product database 10, so that the digital image 6 contains all the data available at the time of production of the timestamp 4. In addition, the digital image is provided with the timestamp. The product database 10 can in this case be hosted, for example, by the field device manufacturer. The digital image 6, which comprises “only” the data, is further encapsulated in an asset administration shell, so that the digital twin 1 is generated as a digital representative of the two-wire field device. Furthermore, an IP address is assigned to the digital twin 1, so that the digital twin 1 can be used as an Industry 4.0 component.

In a next method step f), an authenticated link 7 for downloading the digital twin is produced and provided by the cloud. The link can be provided to the field device operator by the field device manufacturer, for example. In method step e), the digital twin 1 can then be downloaded to and executed on a computer unit 9, for example a computer unit of the field device operator, with the aid of the link. After the digital twin 1 is executed, a digital “copy” of the two-wire field device 2 thus runs on the computer unit 9, which digital copy can be integrated into the IT world outside the automation system 15 via the IP address.

In a next method step h), the method according to the invention provides that the digital twin 1 executed on the computer unit 9 is connected to the product database 10 hosted in the cloud 5. All the master data relevant to the two-wire field device 2 and all the product data relating to a life cycle of the two-wire field device are held in the product database 10. Especially, a serial number of the two-wire field device 2 is held as master data, which are also referred to as product master data. Furthermore, product data are also held in the product database 10 in combination with the asset administration shell, so that the most up-to-date asset administration shell for the two-wire field device is preferably always present in the product database 10. In addition to the serial number, further relevant product attributes can also be held as master data or product master data. Especially, the further relevant product attributes can be designed according to eCl@ss. eCl@ss is a global, ISO/IEC-compliant data standard for the classification and unambiguous description of products and services using standardized ISO-compliant features.

After the digital twin 1 has been connected to the product database 10, a check is carried out in a next method step i) as to whether the product data held in the product database 10 have undergone a change in comparison with the data that were supplied to the digital image 1 at the time of the timestamp 4. The check is preferably carried out at regular intervals. The change may relate to a change in the asset administration shell 8, the master data or the life cycle data. If a change in the product data held in the product database 10 in comparison with the data stored in the digital image has taken place or takes place, it can also be provided that a trigger signal 11 is output by the digital twin 1. As shown in FIG. 1, the trigger signal 11 can preferably be output to a maintenance management system (abbreviated as: CMMS) 12 of the operator of the two-wire field device 2, so that the field device operator is informed of the change. As a result, the field device operator is enabled to make any necessary changes to the two-wire field device 2. Life cycle data can be, for example, an “order stop” date or a “last repair” date.

Depending on the specific nature of the connecting unit 3, i.e., whether it is designed as a stationary or mobile unit, the method is repeated after a change has been determined. If the connecting unit 3 is designed as a stationary unit permanently connected to the two-wire field device 2, method steps c) to i) are carried out again. If the connecting unit 3 is designed as a mobile unit that is disconnected from the two-wire field device 2 after the data is downloaded according to method step b), the complete method (method steps a) to i)) is carried out again.

### List of Reference Signs

1 Digital twin

2 Automation engineering field device

3 Connecting unit

4 Timestamp

5 Cloud

6 Digital image

7 Authenticated link

8 Asset administration shell

9 Computer unit

10 Product database

11 Trigger signal

12 Maintenance management system or CMMS

13 Wireless connection

14 Connecting line

15 Automation system

1-9. (canceled)

10. A method for providing a digital twin for a nondigital automation engineering field device, comprising the following method steps:
connecting a connecting unit to the nondigital field device;
downloading data that are held in the nondigital field device to the connecting unit;
producing a timestamp for the downloaded data;
transmitting the downloaded data together with the timestamp to a cloud;
instantiating a digital image of the nondigital field device in the cloud, wherein the transmitted data and further data specific to the nondigital field device that are held in the cloud are supplied to the digital image, so that the digital image comprises all the data available for the nondigital field device at a time of the timestamp, wherein the digital image is also provided with the timestamp;
producing and providing an authenticated link for downloading the digital twin for the nondigital field device from the cloud, wherein the digital twin comprises at least one asset administration shell and the digital image with the timestamp;
downloading the digital twin with the aid of the link and executing the digital twin on a computer unit, which is preferably operated by an operator of the nondigital field device;
linking the digital twin executed on the computer unit to a product database located in the cloud, which product database comprises product data that contain at least all the master data relevant to the nondigital field device, especially also a serial number, all the relevant data relating to a life cycle of the nondigital field device and/or the asset administration shell;
checking whether the product data held in the product database have undergone a change in comparison with the data that were supplied to the digital image at the time of the timestamp.

11. The method according to claim 10, wherein a further check is carried out as to whether there has been a change in the asset administration shell in comparison with the asset administration shell of the digital image.

12. The method according to claim 10, wherein, if there was a change in the data held in the product database in comparison with the data held in the digital image and/or a change in the asset administration shell, a trigger signal is output by the digital twin.

13. The method according to claim 10, wherein the trigger signal is output from the digital twin to a maintenance management system of the operator of the nondigital field device, so that the operator of the nondigital field device is informed of the change.

14. The method according to claim 10, wherein a serial number, one or more parameters and/or one or more measured values are downloaded as data from the nondigital field device.

15. The method according to claim 10, wherein the connecting unit is connected to the nondigital field device via a wireless connection.

16. The method according to claim 10, wherein the connecting unit is connected to the nondigital field device using a connecting line.

17. The method according to claim 10, wherein the connecting unit is designed as a stationary unit that is permanently connected to the nondigital field device, and wherein, if a change is detected, the method steps are repeated.

18. The method according to claim 10, wherein the connecting unit is designed as a mobile unit that, after the data is downloaded according to the method, is disconnected from the nondigital field device, and wherein, if a change is detected, the method steps are repeated.
